(19) United States
(12) Patent Application Publication
(10) Pub. No.: US 2016/0189647 A1
(43) Pub. Date: Jun. 30, 2016

(54) GOA CIRCUIT APPLIED TO LIQUID CRYSTAL DISPLAY DEVICE

(71) Applicant: SHENZHEN CHINA STAR OPTOELECTRONICS TECHNOLOGY CO., LTD., Shenzhen (CN)

(72) Inventors: Juncheng Xiao, Shenzhen (CN); Mang Zhao, Shenzhen (CN); Yong Tian, Shenzhen (CN)

(21) Appl. No.: 14/418,080

(22) PCT Filed: Jan. 8, 2015
(86) PCT No.: PCT/CN2015/070320

§ 371 Date: Jan. 29, 2015

(30) Foreign Application Priority Data
Dec. 30, 2014 (CN) 201410844668.4

(51) Int. Cl. G09G 3/36

(52) U.S. Cl. CPC G09G 3/3648; G09G 3/3696; G09G 3/3674; G09G 2300/0408; G09G 2310/08

(57) ABSTRACT

A GOA (Gate On Array) circuit applied to a liquid crystal display device is disclosed. The liquid crystal display device has a plurality of scan lines, The GOA circuit has a plurality of cascaded GOA units. An (N)th level GOA unit controls charge to an (N)th level scanning line. The (N)th level GOA unit includes a forward-reward scan circuit, a pull-up circuit, an bootstrap capacitor circuit, a pull-up control circuit, and a pull-down sustain circuit. The pull-up circuit, the bootstrap capacitor circuit, the pull-up control circuit, and the pull-down sustain circuit are connected with a gate signal point. The forward-reward scan circuit is connected with an (N−1)th level scanning line and an (N+1)th level scanning line, so as to raise the stability of the gate signal point and reduce the usages of thin film transistors.

### BACKGROUND O THE INVENTION

1. Field of Invention

The present invention relates to the field of liquid crystal display technology, and more particularly to, a GOA (Gate Driver on Array) circuit of a PMOS (P-channel Metal Oxide Semiconductor) based on LTPS (Low-Temperature Poly-Si), which is applied for a liquid crystal display device.

2. Description of Prior Art

GOA is a technology which utilizes the existing array process of TFT (Thin Film Transistor) liquid crystal display to manufacture the gate scanning signal circuits on the array substrates, to accomplish the cascade scanning on gate electrodes.

With the development of LTPS TFTs, due to the characteristic of extreme super-high carrier mobility of LTPS by itself, the relative integrated circuits around the panels, such as GOA, has become the focus concerned for the public. Many people are investing in the research of the corresponding technology of SOP (System On Panel), and thus the technology gradually becomes accomplished. LTPS can adjust the types of TFT by ion-coating technology to choose NMOS (N type Metal Oxide Semiconductor), PMOS (P type Metal Oxide Semiconductor), or CMOS (Complementary Metal Oxide Semiconductor) circuits, However, compared to PMOS, the mask costs are greatly increased in CMOS and NMOS. Also, the circuit structure of CMOS is too complicated to achieve an extreme narrow bezel design, and when focusing on display devices with smaller sizes, this will become much more important. Thus, PMOS circuits have become the mainstream due to the advantages of cost and circuit structure. Moreover, signal usage and power consumption are important issues in GOA circuits, which needs to be considered when designing LTPS circuits. Furthermore, since the scanning characteristic of small size products such as forward scanning and reverse scanning are more important than other characteristics, a GOA circuit based on LTPS PMOS is helpful to solve the above issues.

### SUMMARY OF THE INVENTION

An objective of the present invention is to provide a GOA circuit of PMOS based on LTPS, which is applied for a liquid crystal display device.

To achieve the above objective, the present invention provides a GOA circuit applied to a liquid crystal display device, the liquid display device comprises a plurality of scanning lines. The GOA circuit comprises a plurality of cascaded GOA units, wherein an (N)th level GOA unit controls charge to an (N)th level scanning line. The (N)th level GOA unit comprises a forward-reward scan circuit, a pull-up circuit, a bootstrap capacitor circuit, a pull-up control circuit, and a pull-down sustain circuit. The pull-down sustain circuit is connected with the (N)th level scanning line. The bootstrap capacitor circuit is connected with the pull-down sustain circuit. The pull-up control circuit is connected with the bootstrap capacitor circuit. The forward-reward scan circuit is connected with the pull-up control circuit. The pull-up circuit is connected with the bootstrap capacitor circuit.

The pull-up circuit, the bootstrap capacitor circuit, the pull-up control circuit, and the pull-down sustain circuit are connected together with each other to form a gate signal point.

The pull-up circuit, the bootstrap capacitor circuit, and the pull-down sustain circuit are respectively connected with the (N)th level scanning line.

The forward-reward scan circuit is respectively connected with an (N−1)th level scanning line and an (N+1)th level scanning line.

The pull-down sustain circuit comprises:

A first TFT (thin film transistor) having a control terminal which is connected with an input terminal of the first TFT and receives a first clock signal, and having an output terminal connected with a first circuit point;

A second TFT having a control terminal which receives a second clock signal, having an input terminal connected with a high constant voltage, and having an output terminal connected with the first circuit point;

A third TFT having a control terminal which is connected with the first circuit point, having an input terminal connected with the high constant voltage, and having an output terminal connected with the (N)th level scanning line;

A fourth TFT having a control terminal which receives the second clock signal, having an input terminal connected with the gate signal point, and having an output terminal connected with the (N)th level scanning line; and

A first capacitor having two ends which are respectively connected with the high constant voltage and the first circuit point.

In one embodiment, the forward-reward scan circuit comprises:

A fifth TFT having a control terminal which receives an up-to-down control signal, having an input terminal connected with the (N−1)th level scanning line, and having an output terminal connected with the pull-up control circuit;

A sixth TFT having a control terminal which receives a down-to-up control signal, having an input terminal connected with the (N+1)th level scanning line, and having an output terminal connected with the output terminal of the fifth TFT and the pull-up control circuit.

In one embodiment, the pull-up circuit comprises:

A seventh TFT having a control terminal which is connected with the gate signal point, having an input terminal receives the second clock signal, and having an output terminal connected with the (N)th level scanning line.

In one embodiment, the bootstrap capacitor circuit comprises:

A second capacitor having two ends which are respectively connected with the gate signal point and the (N)th level scanning line.

In one embodiment, the pull-up control circuit comprises:

A eighth TFT having a control terminal which receives the first clock signal and connected with the control terminal of the first TFT, having an input terminal connected with the output terminal of the fifth TFT and the output terminal of the sixth TFT, and having an output terminal connected with the gate signal point.

In one embodiment, the first clock signal and the second clock signal are reverse signals with regard to each other.

With the technical proposal of the present invention, the advantages are as follows:

1. A GOA circuit design based on LTPS PMOS.

2. A forward and rearward scanning control function, which ensures that variant driving types of the display devices are stable during long-term operation.

3. With the arrangement of first clock signal, the first capacitor and the second capacitor, the high potential of the (N)th level scanning line is maintained, and the pull up and pull down of the gate signal point is accomplished. With the arrangement of the second clock signal, the first capacitor, and the second capacitor, the pull down function of the gate signal point and the (N)th level scanning line is accomplished. With this arrangement, usages of signal lines and the amount of TFTs are reduced in the circuit.

4. The fourth TFT is used to connect the gate signal point with the (N)th level scanning line, and control the fourth TFT with the first clock signal, the stability of the gate signal point is raised and the driving ability of the signal is raised.

### BRIEF DESCRIPTION OF THE DRAWINGS

FIG. 1 is a circuit diagram of a GOA circuit according to the present invention.

FIG. 2 is a waveform diagram of the key nodes during actual operation of the GOA circuit shown in FIG. 1.

### DETAILED DESCRIPTION OF THE PREFERRED EMBODIMENTS

The following description of each embodiment, with reference to the accompanying drawings, is used to exemplify specific embodiments which may be carried out in the present invention. Directional terms mentioned in the present invention, such as “top”, “bottom”, “front”, “back”, “left”, “right”, “inside”, “outside”, “side”, etc., are only used with reference to the orientation of the accompanying drawings. Therefore, the used directional terms are intended to illustrate, but not to limit, the present invention. In the drawings, units with similar structures are marked with the same labels.

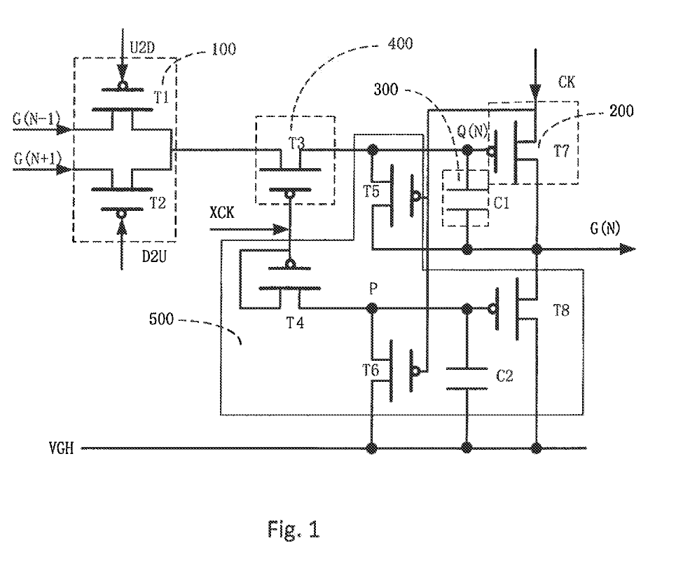

FIG. 1 is a circuit diagram of a GOA circuit according to the present invention. The liquid display device comprises a plurality of scanning lines. The GOA circuit comprises a plurality of cascaded GOA units, wherein an (N)th level GOA unit controls charge to an (N)th level scanning line. The (N)th level GOA unit comprises a forward-reward scan circuit (100), a pull-up circuit (200), a bootstrap capacitor circuit (300), a pull-up control circuit (400), and a pull-down sustain circuit (500).

The pull-down sustain circuit (500) is connected with the (N)th level scanning line (G(N)). The bootstrap capacitor circuit (300) is connected with the pull-down sustain circuit (500). The pull-up control circuit (400) is connected with the bootstrap capacitor circuit (300). The forward-reward scan circuit (100) is connected with the pull-up control circuit (400). The pull-up circuit (200) is connected with the bootstrap capacitor circuit (300).

The pull-up circuit (200), the bootstrap capacitor circuit (300), the pull-up control circuit (400), and the pull-down sustain circuit (500) are connected together with each other to form a gate signal point (Q(N)). The pull-up circuit (200), the bootstrap capacitor circuit (300), and the pull-down sustain circuit (500) are respectively connected with the (N)th level scanning line (G(N)). The forward-reward scan circuit (100) is respectively connected an (N-1)th level scanning line (G(N−1)) and an (N+1)th level scanning line (G(N+1)).

The pull-down sustain circuit (500) comprises:

A first TFT (T4) having a control terminal which is connected with an input terminal of the first TFT (T4) and receives a first clock signal (XCK), and an output terminal of the first TFT (T4) connected with a first circuit point (P(N));

A second TFT (T6) having a control terminal which receives a second clock signal (CK), having an input terminal connected with a high constant voltage (VGH), and having an output terminal connected with the first circuit point (P(N));

A third TFT (T8) having a control terminal which is connected with the first circuit point (P(N)), having an input terminal connected with the high constant voltage (VGH), and having an output terminal connected with the (N)th level scanning line (G(N));

The fourth TFT (T5) having a control terminal which receives the second clock signal (CK), having an input terminal connected with the gate signal point (Q(N)), and having an output terminal connected with the (N)th level scanning line (G(N)); and

A first capacitor (C2) having two ends which are respectively connected with the high constant voltage (VGH) and the first circuit point (P(N)).

The forward-reward scan circuit (100) comprises a fifth TFT (T1) and a sixth TFT (T2). The fifth TFT (T1) comprises a control terminal which receives an up-to-down control signal (U2D), an input terminal connected with the (N−1)th level scanning line (G(N−1)), and an output terminal connected with the pull-up control circuit (400), The sixth TFT (T2) comprises a control terminal which receives a down-to-up control signal (D2U), an input terminal connected with the (N+1)th level scanning line (G(N+1)), and an output terminal connected with the output terminal of the fifth TFT (T1) and the pull-up control circuit (400). The forward-reward scan circuit (100) is responsible for the forward and rearward scanning of the circuit, the control of the pull-up signal, and cascade transfer inside the circuit.

The pull-up circuit (200) comprises a seventh TFT (T7) comprises a control terminal which is connected with the gate signal point (Q(N)), an input terminal receives the second clock signal (CK), and an output terminal connected with the (N)th level scanning line (G(N)).

The bootstrap capacitor circuit (300) comprises a second capacitor (C1) comprises two ends which are respectively connected with the gate signal point (Q(N)) and the (N)th level scanning line (G(N)).

The pull-up control circuit (400) comprises an eighth TFT (T3) comprises a control terminal which receives the first clock signal (XCK) and connected with the control terminal of the first TFT (T4), an input terminal connected with the output terminal of the fifth TFT (T1) and the output terminal of the sixth TFT (T2), and an output terminal connected with the gate signal point (Q(N)).

The first TFT to the eighth TFT are PMOS (P-channel Metal Oxide Semiconductor) TFTs. The control terminal indicates a gate electrode, the input terminal indicates a source electrode, and the output terminal indicates a drain electrode.

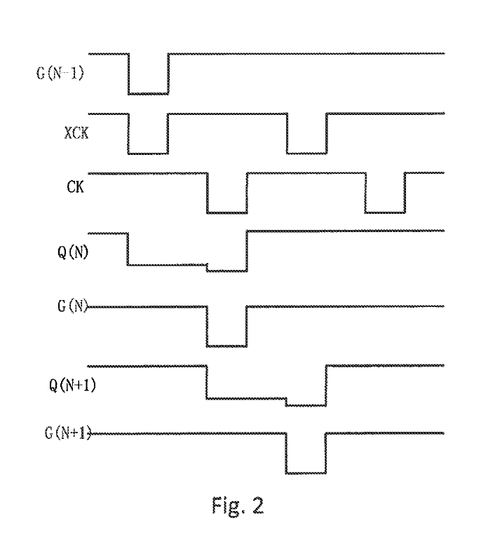

FIG. 2 is a waveform diagram of the key nodes of the GOA circuit during actual operation of the GOA circuit shown in FIG. 1. The pull-up circuit (200) is responsible for the output of the second clock signal (CK), with reasonably controlling the potential of the gate signal point (Q(N)), and effectively outputting the desired driving waveform of the (N)th level scanning line (G(N)). With a special design herein, the fourth TFT (T5) is used to connect the gate signal point (Q(N)) with the (N)th level scanning line (G(N)), and is controlled by the second clock signal (CK). When the second clock signal (CK) is on low potential, the circuit is pulled-down, the (N)th level scanning line (G(N)) and the gate signal point (Q(N)) are conducted to make the gate signal point (Q(N)) stable and to raise the output driving ability. When the second clock signal (CK) is on low potential, the second TFT (T6) is turned on, a storage terminal of the first capacitor (C2) is pulled-up, and the third TFT (T8) is turned off, thereby making the output of the (N)th level scanning line (G(N)) not be affected by the high constant voltage (VGH).

The pull-up control circuit (400) is responsible for the pull-up and pull-down of the potential of the gate signal point (Q(N)) to ensure the second clock signal (CK) outputs well. The potential process of the gate signal point (Q(N)) is a key of the circuit which will decide the capability of the circuit and the performance of the panel.

In the design of the present invention, the (N)th level scanning line (G(N)) is responsible for the up-and-down cascaded transmission of the circuit.

In signal setting, the constant high voltage (VGH) is a high potential with constant voltage and direct current, the first clock signal (XCK) and the second clock signal (CK) are reverse signals with regard to each other.

Although the present invention has been disclosed as preferred embodiments, the foregoing preferred embodiments are not intended to limit the present invention, Those of ordinary skill in the art, without departing from the spirit and scope of the present invention, can make various kinds of modifications and variations to the present invention. Therefore, the scope of the claims of the present invention must be defined.

What is claimed is:

1. A GOA (Gate Driver on Array) circuit applied to a liquid crystal display device, the liquid display device comprising a plurality of scanning lines, the GOA circuit comprising a plurality of cascaded GOA units, wherein an (N)th level GOA unit controls charge to an (N)th level scanning line (G(N)), the (N)th level GOA unit comprises:
a pull-down sustain circuit (500) connected with the (N)th level scanning line (G(N));
a bootstrap capacitor circuit (300) connected with the pull-down sustain circuit (500);
a pull-up control circuit (400) connected with the bootstrap capacitor circuit (300);
a forward-reward scan circuit (100) connected with the pull-up control circuit (400); and
a pull-up circuit (200) connected with the bootstrap capacitor circuit (300);
wherein the pull-up circuit (200), the bootstrap capacitor circuit (300), the pull-up control circuit (400), and the pull-down sustain circuit (500) are connected together with each other to form a gate signal point (Q(N));
the pull-up circuit (200), the bootstrap capacitor circuit (300,) and the pull-down sustain circuit (500) are respectively connected with the (N)th level scanning line (G(N));
the forward-reward scan circuit (100) is respectively connected with an (N−1)th level scanning line (G(N−1)) and an (N+1)th level scanning line (G(N+1));
the pull-down sustain circuit (500) comprises:
a first TFT (thin film transistor) (T4) having a control terminal which is connected with an input terminal and receives a first clock signal (XCK), and having an output terminal connected with a first circuit point (P(N));
a second TFT (T6) having a control terminal which receives a second clock signal (CK), having an input terminal connected with a high constant voltage (VGH), and having an output terminal connected with the first circuit point (P(N))
a third TFT (18) having a control terminal which is connected with the first circuit point (P(N)), having an input terminal connected with the high constant voltage (VGH), and having an output terminal connected with the (N)th level scanning line (G(N)):
a fourth TFT (T5) having a control terminal which receives the second clock signal (CK), having an input terminal connected with the gate signal point (Q(N)), and having an output terminal connected with the (N)th level scanning line (G(N));
a first capacitor (C2) having two ends which are respectively connected with the high constant voltage (VGH) and the first circuit point (P(N)):
the forward-reward scan circuit (100) comprises:
a fifth TFT (T1) having a control terminal which receives an up-to-down control signal (U2D), having an input terminal connected with the (N−1)th level scanning Brie (G(N−1)), and having an output terminal connected with the pull-up control circuit (400); and
a sixth TFT (T2) having a control terminal which receives a down-to-up control signal (D2U), having an input terminal connected with the (N+1)th level scanning line (G(N+1)), and having an output terminal connected with the output terminal of the fifth TFT (T1) and the pull-up control circuit (400);
the first clock signal (XCK) and the second clock signal (CK) are reverse signals with regard to each other.

2. The GOA circuit applied to the liquid crystal display device according to claim 1, wherein the pull-up circuit (200) comprises:
a seventh TFT (T7) having a control terminal connected with the gate signal point (Q(N)), having an input terminal receives the second clock signal (CK), and having an output terminal connected with the (N)th level scanning line (G(N)).

3. The GOA circuit applied to the liquid crystal display device according to claim 1, wherein the bootstrap capacitor circuit (300) comprises:
a second capacitor (C1) having two ends which are respectively connected with the gate signal point (Q(N)) and the (N)th level scanning line (G(N)).

4. The GOA circuit applied to the liquid crystal display device according to claim 1, wherein the pull-up control circuit (400) comprises:
an eighth TFT (T3) having a control terminal which receives the first clock signal (XCK) and connected with the control terminal of the first TFT (T4), having an input terminal connected with the output terminal of the fifth TFT (T1) and the output terminal of the sixth TFT (T2), and having an output terminal connected with the gate signal point (Q(N)).

5. A GOA (Gate Driver on Array) circuit applied to a liquid crystal display device, the liquid display device comprising a plurality of scanning lines, the GOA circuit comprising a plurality of cascaded GOA units, wherein an (N)th level GOA unit controls charge to an (N)th level scanning line (G(N)), the (N)th level GOA unit comprises:
a pull-down sustain circuit (500) connected with the (N)th level scanning line (G(N));
a bootstrap capacitor circuit (300) connected with the pull-down sustain circuit (500);
a pull-up control circuit (400) connected with the bootstrap capacitor circuit (300);
a forward-reward scan circuit (100) connected with the pull-up control circuit (400); and
a pull-up circuit (200) connected with the bootstrap capacitor circuit (300);
wherein the pull-up circuit (200), the bootstrap capacitor circuit (300), the pull-up control circuit (400), and the pull-down sustain circuit (500) are connected together with each other to form a gate signal point (Q(N));
the pull-up circuit (200), the bootstrap capacitor circuit (300), and the pull-down sustain circuit (500) are respectively connected with the (N)th level scanning line (G(N));
the forward-reward scan circuit (100) is respectively connected with an N-1)th level scanning line (G(N−1)) and an (N+1)th level scanning line(G(N+1));
the pull-down sustain circuit (500) comprises:
a first TFT (T4) having a control terminal which is connected with an input terminal and receives a first clock signal (XCK), and having an output terminal connected with a first circuit point (P(N));
a second TFT (T6) having a control terminal which receives a second clock signal (CK), having an input terminal connected with a high constant voltage (VGH), and having an output terminal connected with the first circuit point (RN));
a third TFT (T8) having a control terminal which is connected with the first circuit point (P(N)), having an input terminal connected with the high constant voltage (VGH), and having an output terminal connected with the (N)th level scanning line (G(N));
a fourth TFT (T5) having a control terminal which receives the second clock signal (CK), having an input terminal connected with the gate signal point (Q(N)), and having an output terminal connected with the (N)th level scanning line (G(N));
a first capacitor (C2) having two ends which are respectively connected with the high constant voltage (VGH) and the first circuit point (P(N));
the forward-reward scan circuit (100) comprises:
a fifth TFT (TI) having a control terminal which receives an up-to-down control signal (U2D), having an input terminal connected with the (N−1)th level scanning line (G(N−1)). and having an output terminal connected with the pull-up control circuit (400);
a sixth TFT (T2) having a control terminal which receives a down-to-up control signal (D2U), having an input terminal connected with the (N+1)th level scanning line (G(N+1)), and having an output terminal connected with the output terminal of the fifth TFT (T1) and the pull-up control circuit (400).

6. The GOA circuit applied to the liquid crystal display device according to claim 5, wherein the pull-up circuit (200) comprises:
a seventh TFT (T7) having a control terminal which is connected with the gate signal point (Q(N)), having an input terminal receives the second clock signal (CK), and having an output terminal connected with the (N)th level scanning line (G(N)).

7. The GOA circuit applied to the liquid crystal display device according to claim 5, wherein the bootstrap capacitor circuit (300) comprises:
a second capacitor (C1) having two ends which are respectively connected with the gate signal point (Q(N)) and the (N)th level scanning line (G(N)).

8. The GOA circuit applied to the liquid crystal display device according to claim 5, wherein the pull-up control circuit (400) comprises:
an eighth TFT (T3) having a control terminal which receives the first clock signal (XCK) and connected with the control terminal of the first TFT (T4), having an input terminal connected with the output terminal of the fifth TFT (T1) and the output terminal of the sixth TFT (T2), and having an output terminal connected with the gate signal point (Q(N)).

9. The GOA circuit applied to the liquid crystal display device according to claim 5, wherein the first clock signal (XCK) and the second clock signal (CK) are reverse signals with regard to each other.

10. A GOA (Gate Driver on Array) circuit applied to a liquid crystal display device, the liquid display device comprising a plurality of scanning lines. the GOA circuit comprising a plurality of cascaded GOA units, wherein an (N)th level GOA unit controls charge to an (N)th level scanning line (G(N)), the (N)th level GOA unit comprises:
a pull-down sustain circuit (500) connected with the (N)th level scanning line (G(N));
a bootstrap capacitor circuit (300) connected with the pull-down sustain circuit (500);
a pull-up control circuit (400) connected with the bootstrap capacitor circuit (300);
a forward-reward scan circuit (100) connected with the pull-up control circuit (400); and
a pull-up circuit (200) connected with the bootstrap capacitor circuit (300);
wherein the pull-up circuit (200), the bootstrap capacitor circuit (300), the pull-up control circuit (400), and the pull-down sustain circuit (500) are connected together with each other to form a gate signal point (Q(N));
the pull-up circuit (200), the bootstrap capacitor circuit (300), and the pull-down sustain circuit (500) are respectively connected with the (N)th level scanning line (G(N)):
the forward-reward scan circuit (100) is respectively connected with an (N−1)th level scanning line (G(N−1)) and an (N+1)th level scanning line(G(N+1));
the pull-down sustain circuit (500) comprises:
a first TFT (Thin film transistor) (T4) having a control terminal which is connected with an input terminal of the first TFT (T4) and receives a first clock signal (XCK), and having an output terminal connected with a first circuit point (P(N));
a second TFT (T6) having a control terminal which receives a second clock signal (CK), having an input terminal connected with a high constant voltage (VGH), and having an output terminal connected with the first circuit point (P(N));
a third TFT (T8) having a control terminal which is connected with the first circuit point (P(N)), having an input terminal connected with the high constant voltage (VGH), and having an output terminal connected with the (N)th level scanning line (G(N));
a fourth TFT (T5) having a control terminal which receives the second clock signal (CK), having an input terminal connected with the gate signal point (Q(N)), and having an output terminal connected with the (N)th level scanning line (G(N));
a first capacitor (C2) having two ends respectively connected with the high constant voltage (VGH) and the first circuit point (P(N)).

11. The GOA circuit applied to the liquid crystal display device according to claim 10, wherein the forward-reward scan circuit (100) comprises:
a fifth TFT (T1) having a control terminal which receives an up-to-down control signal (U2D), having an input terminal connected with the (N−1)nth level scanning line (G(N−1)), and having an output terminal connected with the pull-up control circuit (400); and
a sixth TFT (T2) having a control terminal which receives a down-to-up control signal (D2U), having an input terminal connected with the (N+1)th level scanning line (G(N+1)), and having an output terminal connected with the output terminal of the fifth TFT (T1) and the pull-up control circuit (400).

12. The GOA circuit applied to the liquid crystal display device according to claim 10, wherein the pull-up circuit (200) comprises:
a seventh TFT (T7) having a control terminal which is connected with the gate signal point (Q(N)), having an input terminal receiving the second clock signal (CK), and having an output terminal connected with the (N)th level scanning line (G(N)).

13. The GOA circuit applied to the liquid crystal display device according to claim 10, wherein the bootstrap capacitor circuit (300) comprises:
a second capacitor (C1) having two ends respectively connected with the gate signal point (Q(N)) and the (N)th level scanning line (G(N)).

14. The GOA circuit applied to the liquid crystal display device according to claim 10, wherein the pull-up control circuit (400) comprises:
an eighth TFT (T3) having a control terminal which receives the first clock signal (XCK) and is connected with the control terminal of the first TFT (T4), having an input terminal connected with the output terminal of the fifth TFT (T1) and the output terminal of the sixth TFT (T2), and having an output terminal connected with the gate signal point (Q(N)).

15. The GOA circuit applied to the liquid crystal display device according to claim 10, wherein the first clock signal (XCK) and the second clock signal (CK) are reverse signals with regard to each other.

16. The GOA circuit applied to the liquid crystal display device according to claim 1, wherein the first TFT to the sixth TFT are PMOS (P-channel Metal Oxide Semiconductor) TFTs.

17. The GOA circuit applied to the liquid crystal display device according to claim 2, wherein the seventh TFT is PMOS (P-channel Metal Oxide Semiconductor) TFT.

18. The GOA circuit applied to the liquid crystal display device according to claim 4, wherein the eighth TFT is PMOS (P-channel Metal Oxide Semiconductor) TFT.

19. The GOA circuit applied to the liquid crystal display device according to claim 5, wherein the first TFT to the sixth TFT are PMOS (P-channel Metal Oxide Semiconductor) TFTs.

20. The GOA circuit applied to the liquid crystal display device according to claim 6, wherein the seventh TFT is PMOS (P-channel Metal Oxide Semiconductor) TFT.

21. The GOA circuit applied to the liquid crystal display device according to claim 8, wherein the eighth TFT is PMOS (P-channel Metal Oxide Semiconductor) TFT.

22. The GOA circuit applied to the liquid crystal display device according to claim 10, wherein the first TFT to the fourth TFT are PMOS (P-channel Metal Oxide Semiconductor) TFTs.

23. The GOA circuit applied to the liquid crystal display device according to claim 11, wherein, the fifth TFT to the sixth TFT are PMOS (P-channel Metal Oxide Semiconductor) TFTs.

24. The GOA circuit applied to the liquid crystal display device according to claim 12, wherein the seventh TFT is PMOS (P-channel Metal Oxide Semiconductor) TFT.

25. The GOA circuit applied to the liquid crystal display device according to claim 14, wherein the eighth TFT is PMOS (P-channel Metal Oxide Semiconductor) TFT.
